(19) United States
(12) Patent Application Publication
(10) Pub. No.: US 2014/0349741 A1
(43) Pub. Date: Nov. 27, 2014

(54) Method and System for Instant Links Social Gaming

(71) Applicant: Scientific Games International, Inc., Newark, DE (US)

(72) Inventor: Charles Martin Boykin, Alpharetta, GA (US)

(73) Assignee: Scientific Games International, Inc., Newark, DE (US)

(21) Appl. No.: 13/902,083

(22) Filed: May 24, 2013

(51) Int. Cl. A63F 13/30

(52) U.S. Cl. CPC A63F 13/12
USPC 463/25

(57) ABSTRACT

Methods, game entries, and systems are provided for allowing players to establish a social network for game play by transmitting play codes to additional players in order to increase the number of players participating in the game and link results between game entries to one another as well as to a future event.

### FIELD OF THE INVENTION

The present invention relates generally to a system and method for conducting lottery games, and more particularly to lottery games involving a social networking experience for players.

### BACKGROUND

Lottery games are a time-honored gaming tradition provided in numerous jurisdictions worldwide. However, as time has progressed, providers of lottery games, such as lottery drawings, bingo, keno, etc., have discovered that maintaining player interest and participation has become more difficult as players lose interest in existing games and demand a more heightened gaming experience.

Typically, lottery games may be conducted by providing either print or electronic tickets at a retail establishment. In some games, a player may play the ticket immediately by scratching off a removable layer to reveal results or may use a code on the ticket to determine the results. If the ticket is a winning ticket, the player may redeem the ticket. In other games, a player may select a group of numbers or symbols, or have same randomly generated, and compare these numbers or symbols to those selected via a future random drawing. Regardless of the form of play, the player's interaction with the ticket is finite and quickly over and limited to involving just that player. In other words, the player's gaming experience is an individual event generally isolated to the particular player.

The gaming industry is continually seeking ways to not only enhance player interaction, but to encourage new players to play existing and new games. With player sophistication increasing, players demand more engaging games and interactive experiences in addition to the chance component associated with playing. What is needed is a way to encourage additional player participation in a game, as well as to allow players to invite additional players to participate in the gaming experience, for example by enabling game players to form a social network in order to heighten game experience, prolong game play, and introduce new players to the game.

### SUMMARY

Objects and advantages of the invention will be set forth in the following description, or may be obvious from the description, or may be learned through practice of the invention. It is intended that the invention include modifications and variations to the system and method embodiments described herein.

The present disclosure provides a solution by allowing players to invite other players to participate in a game in order to create a more social and widespread gaming experience. By allowing a player to invite and involve other players in a game, especially new players that may not have participated in a lottery game before, the gaming experience for both players is shared and heightened.

Indeed, by allowing a first player to involve additional players, a social networking experience may be established for the game that increases player attention and excitement, as well as introduces new players to the game. Given the increasing popularity and use of social networks, such as FACEBOOK, LINKED-IN, and others, players, both existing and new, will quickly identify with the social network relationship provided by the game and enjoy the “community feel” of their play and others being intertwined. This allows game providers to not only provide new ways of gaming, but also allows for introduction of new players via the growth of the social network. Indeed, former players may be reintroduced as the social network established by the game expands to include them via interactions from other players.

In general, the present invention provides a unique lottery game method, systems, and game entries wherein a player may establish a social network of players by distributing a play code associated with an initial entry into a game to a group of other players by buying and using future credits to pay for transmitting the play code. The second, and subsequent players, may further associate other players.

In a particular embodiment, a computer-implemented method is provided for creating a shared social gaming experience. A computer server is configured for allowing a first player to purchase a first game entry, for example an initial lottery ticket. The server assigns a play code to the first game entry and at least a first plurality of indicia to the first game entry. In one embodiment, multiple pluralities of indicia are used and may be grouped in separate sets associated with or appearing on the game entry. The first plurality of indicia are linked to a future event, such as a lottery drawing, keno game, bingo drawing, outcome of a sporting event, etc., such that the occurrence or result of the future event, such as drawing numbers, a particular team winning an event or achieving a particular result, etc., will determine a prize for the first game entry, if the first game entry is a winning entry. The player is allowed to purchase, via the server, at least one future credit, which the player may use (e.g., “spend’) to transfer or transmit the play code on the lottery ticket to a second player. The second player is allowed to then use the play code to create a second game entry. The event of creating the second game entry causes the prize of the first game entry to no longer be based on linking the first plurality of indicia to the result(s) of the future event. Thus, the occurrence or result of the future event no longer determines a prize for the first game entry.

Further, upon creation of the second game entry, the server generates at least a second plurality of indicia for the second game entry. In further embodiments, multiple pluralities of indicia may be associated with or appear on the second entry. The server then bases the prize of the first game entry upon a correlation of matches between the first plurality of indicia and the second plurality of indicia generated for the second game entry. The server also associates a prize with the second game entry based on linking the second plurality of indicia to the result(s) of the same or another future event, such that the future event will determine a prize for the second game entry, if the second game entry is a winning entry. In a further embodiment, the second player may be awarded an additional prize based on the correlation of matches between the first plurality of indicia on the first game entry and the second plurality of indicia on the second entry.

The future credits may be retained with the first game entry by the first player, transferred or transmitted along with the play code, or a portion of the future credits may be retained with the first game entry while another portion is transferred along with the play code. Still further, future credits transferred to the second player may be retained by the second player or transferred by the second player to at least one additional player. Subsequent transfers of the play code are possible as long as there is at least one future credit remaining to use or spend by one of the downstream players for transferring or transmitting the play code to another player. Indeed, future credits may be used in such a way as to provide the play code back to the original player, thereby linking the prize associated with the original player's entry back to the result(s) of the future event, even though the link to the future event was initially cancelled by the first transfer of the play code to another player.

In a still further embodiment, for each subsequent transfer of the play code, no prize associated with a game entry transferring or transmitting the play code is linked to the future event, unless the play code is later transferred back to that player or game entry. The prize of the game entry transferring the play code is determined by a correlation of matches between at least one plurality of indicia associated with the game entry making the transfer and at least one plurality of indicia generated for a next subsequent game entry. The prize for the next subsequent game entry is based on at least one plurality of indicia generated for such subsequent game entry and is linked to the future event, such that the future event will determine a prize for the subsequent game entry, if the next subsequent game entry is a winning entry.

In a further embodiment, the future credit must be used by a set time before occurrence of the result(s) of the future event. If the future credit is not used by the set time, the server will use the future credit to purchase additional entries for each player retaining at least one future credit, wherein at least one plurality of indicia associated with each player's respective game entry will be used for all additional game entries until all future credits are consumed.

In a still further embodiment, the second player may refuse to use the play code and thereby prevent creation of the second game entry, wherein if the second game entry is not created, the first game entry remains linked to the future event. While the second player may refuse to create an entry, the original player may orchestrate other transmissions of the play code to a third, fourth, fifth player, etc., as long as sufficient future credits exist to pay for the transmissions of the play code to other players.

In another embodiment, the first player selects at least the first plurality of player indicia. Alternatively, at least the first plurality of player indicia may be selected for the first player.

In a still further embodiment, the first game entry is a printed ticket, while in another embodiment, the first game entry is an electronic ticket.

In another aspect, the invention encompasses various embodiments of game entries for a social gaming experience as described above. The entry contains at least a first plurality of player indicia that are linked to the result(s) of a future event, for example a lottery drawing, bingo game, sports results, etc., such that the future event will determine a prize for the first game entry in the event that the first game entry is a winning entry. The game entry includes a play code and at least one future credit is associated with the game entry (e.g., may be purchased by the first player). The first player may spend the future credit to transmit the play code to a second player. Transmitting the play code to the second player, and use of the play code by the second player, creates a second game entry. At least a second plurality of indicia are provided, which may be accomplished free of player influence, for the second entry. At this time, the prize for the first game entry is unlinked from the result(s) of the future event and is subsequently determined by a correlation of matches between the first plurality of indicia and the second plurality of indicia that is generated for the second game entry. In a further embodiment, upon creation of the second game entry, the prize for the second game entry is based on the second plurality of indicia and is linked to the result(s) of the future event. Additionally, the second player may also be awarded an additional prize based on the correlation of matches between the first plurality of indicia and the second plurality of indicia.

It should be appreciated that various embodiments of game entries in accordance with the invention may incorporate any one or combination of the features discussed above.

Additional aspects of particular embodiments of the invention will be discussed below with reference to the appended figures.

### BRIEF DESCRIPTION OF THE DRAWINGS

A full and enabling disclosure, including the best mode thereof, to one of ordinary skill in the art, is set forth more particularly in the remainder of the specification, including reference to the accompanying Figures, in which:

FIG. 1 is a flow chart illustrating one method of the disclosure.

FIG. 2 is a flow chart illustrating creation of a second game entry.

FIG. 3 illustrates an example distribution of the play code and future credits.

FIG. 4 illustrates possible permeations of prize associations possible for the present disclosure.

FIG. 5 illustrates a game entry for a social gaming experience per one embodiment of the disclosure.

FIG. 6 illustrates an alternative game entry for a social gaming experience per one embodiment of the disclosure.

FIG. 7 illustrates one possible network for use with the present disclosure.

FIG. 8 illustrates a simplified block diagram of an alternative embodiment of a gaming network.

### DETAILED DESCRIPTION

Reference will now be made in detail to various embodiments of the presently disclosed subject matter, one or more examples of which are set forth below. Each embodiment is provided by way of explanation, not limitation, of the subject matter. In fact, it will be apparent to those skilled in the art that various modifications and variations may be made to the present disclosure without departing from the scope or spirit of the disclosure. For instance, features illustrated or described as part of one embodiment, may be used in another embodiment to yield a still further embodiment. Thus, it is intended that the present disclosure cover such modifications and variations as come within the scope of the appended claims and their equivalents.

In general, the present disclosure is directed to unique lottery game methods, game entries, systems, and computer program products wherein a player may establish a social network amongst a group of players by distributing a play code associated with the initial entry to a group of players by buying and using future credits to pay for transmitting the play code. The second, and subsequent players, may further associate other players to widen the social network.

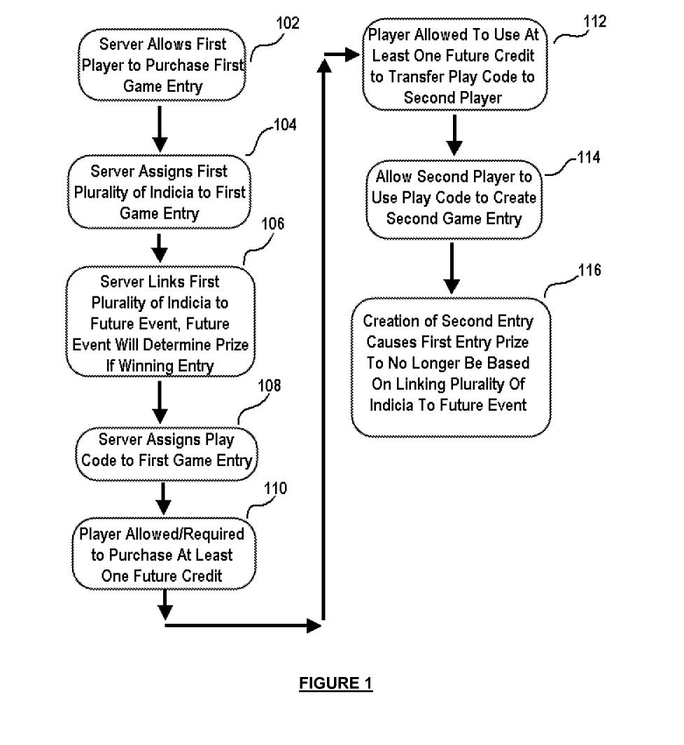

FIG. 1 is a flow chart illustrating one embodiment of a computer-implemented method social network gaming method. At step 102, a server allows a first player to purchase a first game entry. The server, at step 104, assigns at least a first plurality of indicia to the first game entry (which may be chosen by the player or randomly generated by the player) and, at step 106, links the first plurality of indicia to a future event, such as a lottery drawing, outcome of a sporting event, etc., such that occurrence or results of the future event will determine a prize for the first game entry, if the first game entry is a winning entry. The first plurality of indicia is linked to the future event by any process in the server that associates the first plurality of indicia to the future event for determination of a winning play of the first game entry. For example, files may be created and saved within the server (including any configuration of server-based system) for each game entry wherein the stored pluralities of indicia are algorithmically linked, tagged, or otherwise associated with the future event for purposes of determining the win/loss status of the game entries.

The nature of the future event is not a limiting factor and may vary from typical lottery events such as drawings for lottery, bingo or keno games, random number generation events, or future events based on the results of various competitions including sporting events such as football games, sports tournament results, etc. With respect to random number generation events, random generation means as known to those of skill in the art may be employed to provide a result for the future event, such as a number selection, symbol selection, etc., that determines the results of entries linked to the future event.

At step 108, the server assigns a play code to the first game entry, and may associate this play code with a stored file for the game entry. At step 110, the player is allowed, or may be required as part of obtaining a game entry, to purchase at least one future credit, via the same or a different system (e.g., terminal, Internet purchase, etc.) than used to purchase the game entry. The future credit may be purchased at the time of purchase of the game entry, or at a later time, but prior to the future event. The future credits purchased by a player may be associated with the player's game entry file in the server by entering the number of future credits purchased and associating this information via a lottery terminal, server, computer, or other means, with a data or look-up table that correlates the number of future credits purchased, as well as the number of credits subsequently used.

As step 112 shows, the first player may use or spend the future credit to transmit the play code to a second player. The transmission may be affected by providing the second player with a copy of the game code sequence and allowing the second player to use a lottery terminal, an Internet-enable device (e.g., PC, smart phone, etc.), or other game play device to enter the code into the lottery server system and create the second entry. A second game file may be created for this second entry, with the game file being linked or associated with the game file for the first (initial) game entry. This allows for monitoring and linking the social network as it is formed, assuring sufficient future credits exist to allow the transmission or transfer of future credits, as well as allowing the first player to transfer credits to the second player or even allow the first, second or further subsequent players to purchase future credits in order to form their own “branch” or “web” of the social network. Thus, by buying at least one future credit and spending same to transmit the play code to another player, the first player has begun to establish a social network of players and the second player may do the same.

The second player, at step 114, is allowed to use the play code to create a second game entry. The first and second game entries may either be a print ticket, using a stub system or other detachable means to provide subsequent ticket holders with the play code or the entries may be electronic game tickets. In a preferred embodiment, a trailer ticket may be used to accomplish the transfer or transmission of the play code. A printed game entry may be provided by a commercial printer, printed in an in-store kiosk, self-service terminal or on a standard gaming terminal, or via other means as known to those of skill in the art. The play code may also be sent through a text message, email, a smart phone QR code, or other electronic means that allows the second player to access a website maintained by the lottery or game provider for conducting the game.

Creating the second game entry, at step 116, causes the prize of the first game entry to no longer be based on linking the first plurality of indicia to the result(s) of the future event. In other words, the system disassociates the result of the future event as the event that determines the outcome of the first game entry. The game file for the first game entry may be modified to reflect this disassociation in any suitable manner.

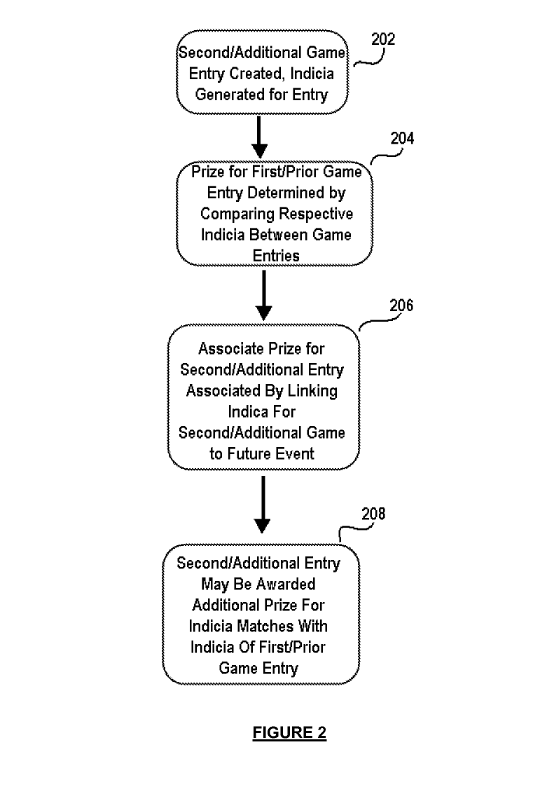

Further, as shown by FIG. 2, upon creation of the second game entry, the server generates at least a second plurality of indicia for the second game entry at step 202, and may save this second plurality of indicia with the respective game file for the second game entry.

At step 204, the server then bases the prize of the first game entry upon a correlation of matches between the first plurality of indicia and the second plurality of indicia. This result is generated and may be stored with the game file associated with the first game entry, and may be made known to the first player essentially immediately after generating the second plurality of indicia by any suitable means. For example, the first player may receive a text message, email, or other notification indicating the result win/loss status of the first game entry after generation of the second game entry. This notification also serves to indicate to the player that the social network they established has started to grow. In an alternative embodiment, the results for the first game entry (and any other subsequent game entries that evolve from the gaming network) may be held from the players until the future event has occurred that determines the winning status of the game entry holding the game code. Thus, in this embodiment, the entirety of the players in the social network are notified of the win/loss status of their game plays at essentially the same time.

The server, at step 206, also associates a prize with the second game entry based on linking the second plurality of indicia to the result(s) of the future event, such that the future event will determine a prize for the second game entry, if the second game entry is a winning entry.

In a further embodiment, the second player may be awarded an additional prize based on the correlation of matches between the first plurality of indicia and the second plurality of indicia as shown at step 208. The additional prize may be based on the number of matches between the respective indicia sets, matching particular indicia between the sets, lack of matching indicia, etc., as known to those of skill in the art. Also, differing prize amounts may be offered based on the number/type of matches occurring between the sets of indicia, also as known to those of skill in the art.

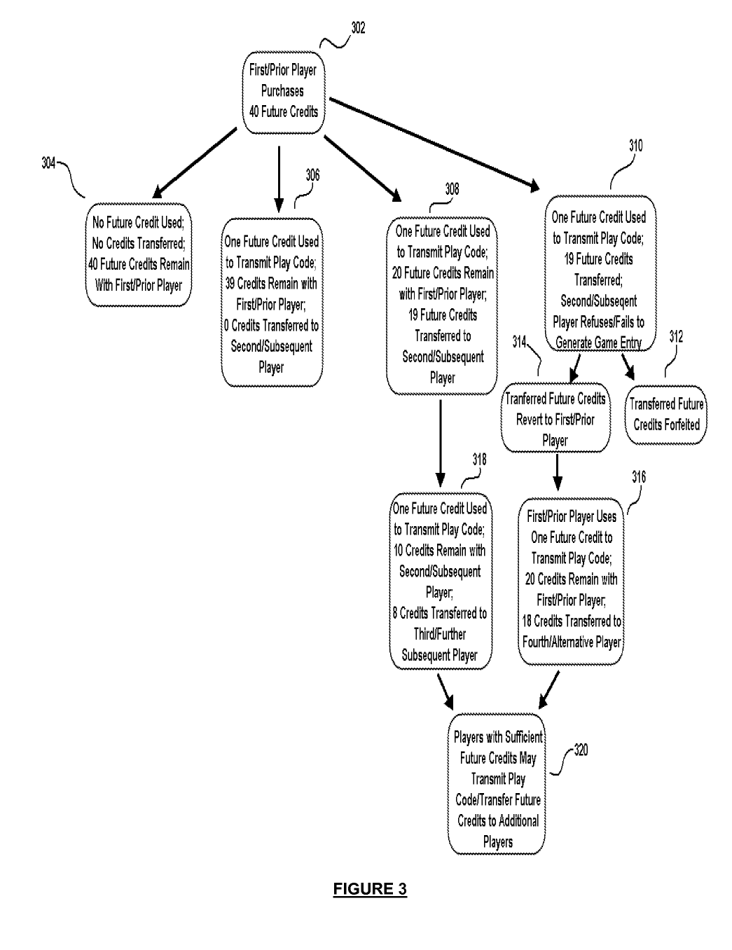

FIG. 3 shows a flow diagram of how future credits may be retained with the first game entry by the first player, transferred along with the play code, or a portion of the future credits may be retained with the first entry while another portion is transferred along with the play code. At step 302, a First/Prior player has purchased 40 future credits, and various options exist to a player with respect to using the future credits. As step 304 illustrates, the player may simply retain all 40 credits, which may be attributed as described in greater detail below. At step 306, instead, the first/prior player may use one future credit to transmit the play code to a second/subsequent player, thereby forming the first link in a game play social network. Alternatively, at step 308, the first/prior player may use one future credit to transfer the play code and then also transfer 19 credits to a second/subsequent player while the first/prior player retains 20 credits for future transmissions or credit transfers in other game plays. Although only one transfer is shown at step 308, numerous transmissions of the play code are possible and within the scope and spirit of the invention. Indeed, a first/prior player may perform a single transmission/transfer to a single player or multiple such transmissions/transfers to multiple players with the number of transmissions/transfers limited only by the cost of conducting the play code transmission and the number of credits sought to be transferred to the subsequent player(s). Players may also be allowed to purchase additional future credits in order to further expand the social network.

The second or subsequent player is free to refuse to participate in the game as shown at step 310. When the second player prevents creation of the second game entry, the first game entry remains linked to the future event, until the play code is transferred to a player that uses the play code to create a game entry. While the second player may refuse to create an entry, the original player may orchestrate other transmissions of the play code to a third, fourth, fifth player, etc., as long as sufficient future credits exist to pay for the transmission or transfer to other players. Thus, it should be appreciated that the play code can be transferred to multiple downstream players at the same time, so long as the first/prior player has sufficient credits to “buy” such transfers.

In a certain embodiment, tf the second player refuses to generate an entry, the first/prior player loses the future credit used or spent for the transmission of the play code. The player may also forfeit any future credits transferred to the second/subsequent player (step 312). Alternatively, the future credits unused by the second/subsequent player may revert to the first/prior player (step 314) under certain conditions. For example, the reversion may occur after a designated time period elapses prior to the occurrence of the future event. The first/prior player may need to inform the game provider that the future credits should be reverted prior to generation of the second game entry. Alternatively, the second/subsequent player may instruct that the future credits and play code be returned to the first player, such as returning the portion of a print ticket provided to the second player, or via other methods as known to those of skill in the art.

If the credits revert, the first/prior player may then transfer these or other credits to other players such as a fourth/alternative player at step 316. Also, other players such as the second/subsequent player, third/further subsequent, fourth/alternative player, etc., are free to further transmit the play code and transfer future credits to additional players, if the player(s) attempting the transmission or transfer possess sufficient credits to pay for the transmission of the play code and future credits remain after the payment to be transferred, see steps 316, 318, and 320.

While a specific number of transfers are illustrated in the drawings, the disclosure is not so limited. Transfers may occur as long as sufficient credits remain to pay for the transmission of the play code and for transferring credits to subsequent players. It should be understood that the foregoing example is provided for purposes of illustration only and should not be considered limiting with respect to the number of players involved or the number of credits transferred. Indeed, more or less players may be involved and more or less credits may be: used to transmit a player code; transferred to another player; or retained by a player and such is clear to one skilled in the art. Further, designating players as first, second, third, fourth, etc., should not be considered to require any particular order among the transfers or dictate the terms of such transfers. Still further, future credits transferred to another player may be retained by that player or transferred to at least one additional player. Subsequent transmissions of the play code are possible as long as there is at least one future credit remaining to use or spend for transmitting the play code to another player. Indeed, codes may be used in such a way as to provide the code back to the original player, thereby linking the prize associated with the original player's entry back to the result(s) of the future event, although the link to the future event was previously cancelled by transferring the play code.

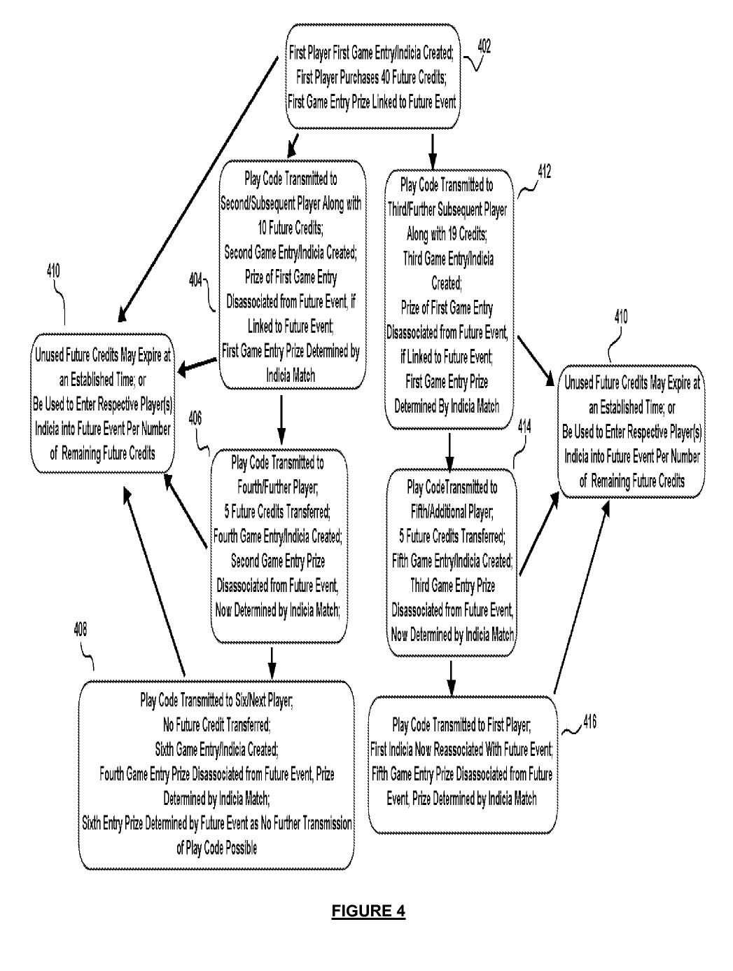

FIG. 4 illustrates possible permeations of prize associations for the present disclosure. A first player purchases a first game entry and 40 future credits. The prize of the first game entry is linked to the future event (step 402). It should be appreciated that the future credits purchased by the first player may simply be one future credit needed to transmit the play code to a subsequent player, or a plurality of future credits that allows for multiple play code transmissions along with possibly transferring additional credits to the subsequent player(s) in order to encourage forming a more robust social network.

When the first player purchases multiple future credits, for instance, these future credits may all be linked to the future event, such that any transfer of a single future credit, or use of a single future credit to transmit the play code to another player, disassociates the first player's game entry from the future event, regardless of the number of future credits transferred or retained. This way, a player purchasing 40 future credits is encouraged to distribute the future credits to as many players as possible in order for the first player to have more possible chances of a successful indicia match when indicia are created for subsequent game entries because the player is disassociated from the future event and her chances of winning are determined solely by the indicia matches.

Alternatively, each future credit may be individually associated with the future event. In this embodiment, the player may retain future credits and have at least the first game entry indicia entered multiple times into the future event. For example, if the future event is a Keno game, the player's set of number indicia, either selected by or for the player, will be entered one time for each retained future credit. This provides the first player multiple entries with respect to the future keno drawing. However, in order to encourage establishing a wider, more diverse social network, it is preferable for a player to have only one association with the future event whereby the player's game entry indicia are linked to the future event. Once the player transmits the play code to another player, whether or not future credits are also transferred, they are encouraged to transmit the code to multiple players in order to improve their chances of winning by having multiple indicia match possibilities.

As FIG. 4 illustrates, after the first player transmits the play code to a second player, along with transferring future credits, a second game entry and associated game entry indicia are created. The indicia for the second game entry may be selected by the player or for the player. In a preferred embodiment, the indicia are generated for the player by a random number generator or other means known to those of skill in the art. Because a future credit has been used to transmit the play code, the prize of the first game entry is now disassociated from the future event. Instead, the prize of the first game entry is determined by matching at least one set (which may include one or all) of indicia associated with the first game entry with at least one set of indicia generated for the second entry. The prize for the second entry is now associated with the future event, see step 404.

Once no further transmissions of the play code are possible, either because no future credits are available to fund a transfer of the play code, or a time limit for making play code transfers has expired, a player or players receiving the final transmission of the play code or being “timed out”, will have at least one set of their respective entry's indicia entered into the future event (step 408). Thus, at least one player is always entered into the future event, whether this is the first player or one or more of the subsequent players receiving the play code. Moreover, subsequent transmissions of the play code are available, if sufficient future credits exist, see step 406. In one aspect, the play code may be transferred in a linear fashion whereby only a single set of indicia associated with a single entry is linked to the future event. Thus, a first player may transfer the play code to a second player and this process may repeat. Ultimately, the last player receiving the code will have her entry linked to the future event.

Alternatively, the play code may be transferred or transmitted in a weblike fashion where the first player can distribute the code to multiple “second tier” players who in turn transmit the code to other players, which may also be single players or a web of subsequent tier players. In this situation, a player in each “strand” of the web will have her entry associated with the future event. Thus, multiple players may have at least one set of indicia from their respective entry associated with the future event.

In a still further embodiment, the play code may be transferred in a weblike fashion but only one entry in one strand of the web will be linked to the future event. This way, the first player may transmit the play code to a second player who then further transmits the play code. The first player may then transmit the play code to another player, such as a third player. Because the first player's entry has already been disassociated from the future event, prizes in the “strand” of the web formed by the first and third player are determined by indicia matches between at least one set of indicia on the first player's entry and at least one set of indicia created for the third player's entry. Although no linking to the future event is possible for this strand, forming and expanding the social network is still encourage via the indicia matching prizes. Further, the link to the future event may “jump” between strands if a player in the strand linked to the future event, transfers the play code to a player in a strand that was not linked to the future event.

In certain embodiments, players receiving the play code are notified that they are linked to the future event. In alternative embodiments, players receiving the play code may not be informed they are linked to the future event until prior to the future event in order to build player excitement.

Unused future credits may expire or, alternatively, may be used to enter a respective player and that player's respective game entry, using the indicia associated with the game entry, into the future event with one entry provided per remaining future credit (step 410). If future credits are not used by the set time, the server may use the future credits to purchase additional entries for each player having the necessary number/amount of such unused future credits, wherein at least one plurality of indicia associated with each player's respective game entry will be used for all additional game entries until the future credits are consumed. A new plurality of indicia may be generated for the game entries purchased with the unused future credits. In a preferred embodiment, the same set of indicia from a player's ticket is used for all entries. However, it should be understood that entries to the future event may be provided on any other basis rather than a one entry per one remaining future credit basis.

In a preferred embodiment, the unused future credits expire once the time has expired for transmitting the player code to additional players. This encourages players to aggressively transmit the play code to other players in order to assure maximum winning potential prior to the deadline for transmitting the play code elapses. The deadline for transmitting the play code may be a specific time period prior to occurrence of the final event. For instance, if the future event is a Keno drawing, all play code transmissions must be complete 5, 10, 15, 20, 30 minutes, etc., before the slated Keno drawing. This may lead to frenzied and exciting transfers, as well as encourages wide distribution of the social network to help optimize a player's chances of winning.

In another embodiment, the first player may have their entry re-associated with the future event. As FIG. 4 shows, a first player may transmit the play code and future credits to a third/subsequent player at step 412. The third player may transmit the code and future credits to a fifth player at step 414, whom may then transmit the play code back to the first player at step 416. In this embodiment, once the first player receives back the play code transmission, the first indicia associated with the first game entry are now re-associated with the future event, even though the player had previously transmitted the code to the third player at step 412. Future credits permitting, the first player may then transmit the code to yet another player as shown by FIG. 4.

Alternatively, the first player may be prohibited from re-associating her indicia with the future event in order to encourage players to transmit the codes to new players. In a particular embodiment, re-transmission of a play code to the first player does not re-associate the first player's entry with the future event. In a still further embodiment, for each subsequent transfer, no prize associated with a game entry transferring the play code is linked to the future event, unless the play code is later transferred back to that player and re-association is permitted (step 416).

Although prizes are discussed herein, it should be understood that no game entry is a guaranteed winner and that a prize association is being provided rather than a guarantee of winning a prize.

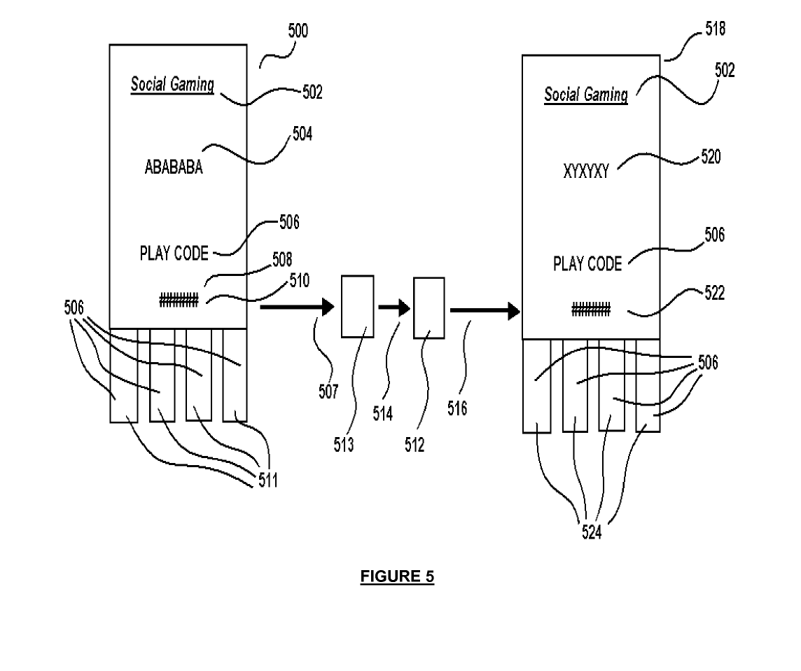

FIG. 5 illustrates a first game entry 500 for a social gaming experience per one embodiment of the disclosure. A theme or motif 502 may be associated with all game entries as understood by those of skill in the art. The game entries may be either a print ticket or an electronic ticket, such as a ticket provided to a player's Internet enabled device. Game entry 500 contains a first plurality of player indicia 504 that are linked to the result(s) of a future event, for example a lottery drawing, Keno drawing, bingo game, sports results, etc., such that the occurrence or result(s) of the future event will determine a prize for first game entry 500, if the first game entry is a winning entry. First game entry 500 includes a play code 506, and at least one future credit 508 is associated with first game entry 500 as shown by future credit counter 510. A first player may use at least one future credit 508 to transmit play code 506 to a second player, not shown. Transmission 507 of play code 506 may occur physically, such as by the first player providing a removable item 511 to the second player that contains the play code 506, such as printed thereon, in barcode form, etc. First game entry 500 may be printed with a number of removable items 511, such as pull tabs, tear off sections, etc., that may reflect the number of future credits the first player bought when purchasing game entry 500, or via other means as known to those of skill in the art. A trailer ticket, as known to those of skill in the art, may also be used to accomplish the transmission of the play code. Or, the first player could simply transmit 507 play code 506 to the second player via verbal communication, email, text, writing, etc., in order for the second player to redeem 514 play code 506 via a lottery terminal, gaming console, smart phone, mobile device, home computer, tablet, or other redemption means 512, etc., in order to create 516 second entry 518.

Transmission of play code 506 may also occur electronically. The first player could email, text, instant message, or otherwise transmit 507 play code 506 to a subsequent player through various media 513 including computers, servers, smart phones, mobile devices, laptop computers, electronic tablets, etc. In other embodiments, transmission is via a smart phone QR code. The subsequent player could then redeem 514 play code 506 to generate 516 second game entry 518, in either print or electronic form as discussed herein. Transmission of play code 506 to the second player, and use of play code 506 by the second player, creates a second game entry 518. (As discussed above, the second player may refuse to use play code 506.) A second plurality of indicia 520 is provided. The second plurality of indicia 520 may be selected by the second or subsequent player or for the second or subsequent player via random number generation means, as known to those of skill in the art. In a preferred embodiment, second plurality of indicia 520 are generated free of player influence for second game entry 518.

After transmission of play code 506, the prize for first game entry 500 is unlinked from the result(s) of the future event, and is determined by a correlation of matches between the first plurality of indicia 504 and the second plurality of indicia 520. In a further embodiment, upon creation of second game entry 518, the prize for second game entry 518 is based on second plurality of indicia 520 that are linked to the result(s) of the future event, such that the future event will determine a prize for second game entry 518, if second game entry 518 is a winning entry.

Additionally, the second player may also be awarded an additional prize based on the correlation of matches between first plurality of indicia 504 and second plurality of indicia 520. Second entry 518 will also possess play code 506 and future credit counter 522 and, for print tickets, removable items 524 to allow the second player to continue to build the social network by creating further subsequent entries via distributing play code 506 to other potential players. The first player may also do the same, as well as any subsequent players receiving sufficient future credits to transmit play code 506.

In an alternative embodiment, second entry 518 may possess a different play code 506 than first game entry 500. However, in a preferred embodiment, play code 506 remains the same as it is transferred from game entry to game entry.

With respect to both the print and electronic tickets, future credits remaining after transmission of play code 506 may be retained with first game entry 500, transferred along with play code 506, or a portion of the remaining future credits may be retained with first game entry 500 and another portion transferred to second and/or subsequent players along with the play code 506. In still another embodiment, future credits transferred to the second player may be retained by the second player or transferred to at least one additional player and subsequent transfers to other players are possible as long as there is at least one future credit remaining to use or spend for transmitting of the play code 506 as shown by the respective tickets future credit counter 510 or 522.

In a still further embodiment, for each subsequent transmission of the play code 506, a prize associated with a game entry transferring play code 506 is no longer linked to the future event. The prize of the game entry transmitting play code 506 is determined by a correlation of matches between the plurality of indicia associated with the entry transmitting the play code and indicia generated for a next subsequent game entry. The prize for the next subsequent game entry is based on the indicia generated for the next subsequent entry and is linked to the future event, such that the result(s) of the future event will determine a prize for the next subsequent game entry, if the next subsequent game entry is a winning entry.

In another embodiment, the at least one future credit 508 must be used by a set time before occurrence of the future event. If the at least one future credit 508 is not used by the set time, the at least one future credit 508 may be used to purchase additional entries for the player using the respective plurality of indicia associated with the respective game entry for all additional entries until the future credits 508 are consumed.

In a further embodiment, the first player selects the first plurality of player indicia 504. In an alternative embodiment, the first plurality of player indicia 504 are selected for the first player. In a still further embodiment, any player having a game entry may purchase additional future credits that the player may retain or pass along to other players in order to further expand the social network. Any such purchased future credits may still be subject to any time deadlines for transferring the tickets as well as the ticket reversion and “auto pick” embodiments disclosed herein with respect to indicia selection.

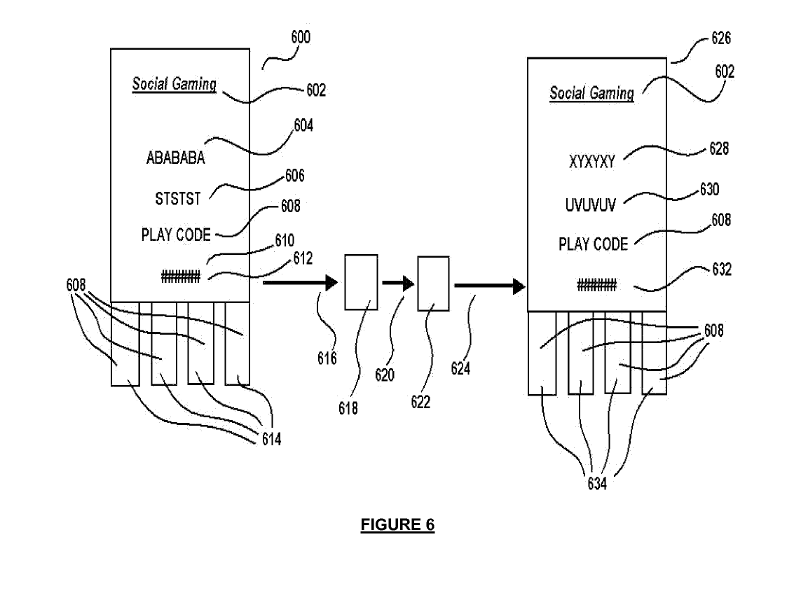

In an alternative embodiment, shown by FIG. 6, a first game entry 600 is provided with a theme or motif 602, as well as a first set of first game entry indicia 604 and a second set of first game indicia 606. The indicia 604 and 606 may contain the same or different numbers of indicia. As described herein, the game entries may be print or electronic game entries. The indicia 604 and 606 may be selected by the player or for the player. In a particular embodiment, the player selects at least one set of the indicia 604 and/or 606. First game entry 600 also includes a play code 608, which may be transmitted as described herein. First game entry 600 also contains at least one future credit 610 and a future credit counter 612, which may be a digital counter or, instead a code, such as an alphanumeric code, associated with the ticket that is used to correlate the number of future credits associated with a respective game entry via a look-up table or other means known to those of skill in the art. With respect to print tickets, removable items 614 may be provided to accommodate a physical transmission of the play code 608 to another player by removing or detaching a portion of first game entry 600 that contains play code 608. Transmission 616 via media 618 as well as redemption 620 via redemption means 622 and creation of second entry 626 of play code 608 may occur as described herein.

In the embodiment illustrated by FIG. 6, each game entry 600 and 626 have two respective sets of indicia, 604, 606, and 628 and 630. For purposes of example only and not intended to be limiting, if player one participates in a social network game based on an instant Keno drawing of 20 of 80 possible numbers, player one may have two sets of indicia 604 and 606 associated with the first game entry. Indicia 604 may be linked to the future Keno drawing such that the results of the keno drawing determine if the first game entry 600 wins a prize based on the correlation between indicia 604 and the results of the numbers selected in the keno drawing. Meanwhile, if the first player transmits play code 608 to a second player, who redeems the code to create second entry 626, indicia 606 of first game entry 600 may be compared to indicia 630 of second game entry 626 to determine if a match exists between the two groups of indicia. Matches therein may entitle either or both players to a prize.

Meanwhile, with respect to indicia 604 and 628, various gaming possibilities exist. In one embodiment, once play code 608 is transmitted, indicia 604 are unlinked from the future Keno drawing, unless the play code 608 is later transferred back to the first player as described herein. Meanwhile, indicia 628 on second game entry 626 is now associated with the future Keno drawing such that the results of the Keno drawing now determine a prize with respect to second entry 626 for indicia 628. Using two sets of indicia allows for game variation by allowing the player to pick, or have selected for them via random number generation means, different sized sets of indicia. One indicia could represent the entry for the Keno drawing while the other set represents a “Quick Pick” set of indicia for comparison with game entries “spawned” from the original entry. Moreover, in further embodiments, both indicia 604 and 628 may remain linked to the future Keno drawing after transmission of play code 608 in order to enhance prize awards and build game excitement. In a preferred embodiment, indicia 604 would become unlinked from the future keno draw when play code 608 is transmitted to another player.

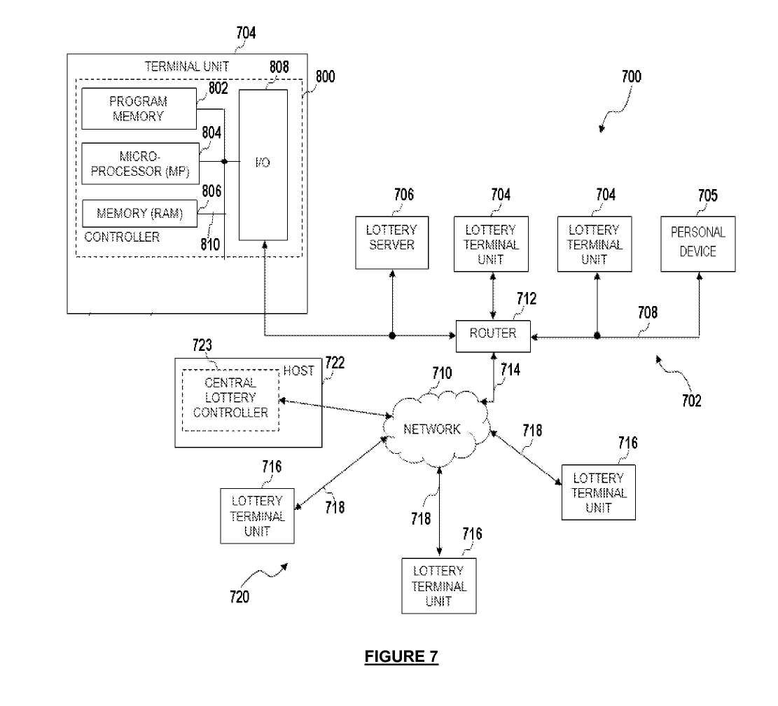

Referring to FIG. 7, in one embodiment, the current social gaming embodiments may operate over a group of lottery terminals 704 operatively coupled to a lottery or gaming authority network 700, which includes a lottery or gaming authority host computer 722. A first group or network 702 of lottery terminal units 704 may be operatively coupled to a lottery network computer or server 706 via a network data link or bus 708. The lottery authority network 700 may be coupled to a communication network 710, which may be, for example, the Internet, a wide area network (WAN), or a local area network (LAN) through a network hub or router 712 via a first network link 714. In one possible configuration, the first network 702 may be a state lottery system operating within an individual state or region of states. In this configuration, the individual lottery terminal units 704 may be interconnected to a central system (e.g., host computer system 722 with central lottery controller 723) for tracking and coordination of the state lottery system, including issued tickets, drawn numbers, and/or amounts wagered. In other embodiments, network 700 may be an internet or cellular based network.

The lottery or gaming authority network 700 may further include other lottery terminal units 716 that may be directly connected to the network 710 through a plurality of direct network links 718, thereby eliminating the need for the bus 708, router 712 or other networking equipment. Each lottery terminal unit 716 in this configuration may represent a group of lottery retailers participating in the social network forming game, as described above, or a plurality of the lottery terminal units 716 may be grouped together to form a lottery node 720. The lottery nodes 720, in turn, may be directly connected and/or multiplexed to the network 710 via the direct network links 718. Further, the direct network links 718 may represent secure communications channels physically hardened against tampering and/or the communications may be encrypted to prevent unauthorized access to information transmitted thereon.

It will be understood that the lottery or gaming authority network 700 illustrated in FIG. 7 may alternatively represent the network layout within a given establishment. In this alternate configuration, each stand-alone lottery terminal unit 704 may be an interactive terminal capable of playing a variety of lottery or casino games, such as a lottery game, keno, bingo, video poker, video blackjack, slots, and the like. Terminal units 704 may be distributed throughout a single establishment and connected with a LAN, or throughout multiple sites and connected with a WAN. Further, the LAN and/or WAN connecting each of the terminal units 704 may include one or more separate and secure buses 708, routers 712, web servers, gateways and other networking equipment to provide continuous and/or redundant connectivity to the network 710. As discussed above, the network 710 may be communicatively connected to a central host computer 722 as well as associated databases to allow for implementation, storage, tracking and analysis of gaming and lottery features.

Indeed, in a still further embodiment, FIG. 7 may represent the network layout of a given configuration wherein personal devices such as home computers, smart phones, tablet devices, mobile devices, mobile device applications, etc., may be used to participate in the present disclosure. Terminal units 704 may be distributed throughout a single establishment and function in conjunction with personal devices 705 and connected with a LAN, or throughout multiple sites and connected with a WAN. Personal devices may be used in place of all disclosed terminals 704 and 716 or used in conjunction therewith. Further, the LAN and/or WAN connecting each of the terminal units 704 and personal devices 705 may include one or more separate and secure buses 708, routers 712, web servers, gateways and other networking equipment to provide continuous and/or redundant connectivity to the network 710.

The methods and game entries herein can be implemented in connection with any suitable hardware, software, firmware or combination thereof. In one embodiment, aspects of the method and game entries can be implemented by components of a client-side application, such as a smart phone, tablet computer, instant messaging application, mobile device application, or other client personal device; and, aspects of the method can be implemented by a server-side application such as a sever or network. It is to be understood that other applications can be utilized without departing from the spirit and scope of the claimed subject matter.

The present invention also encompasses various embodiments of a lottery terminal system wherein a plurality of the lottery terminals 704 as discussed above are communicatively coupled to the lottery authority network 700. The lottery terminals 704 may include any combination of the features and aspects described above. Further, the disclosure herein may also be encompassed in a nontransitory computer medium such as a program or software operated or processed by a server or computer.

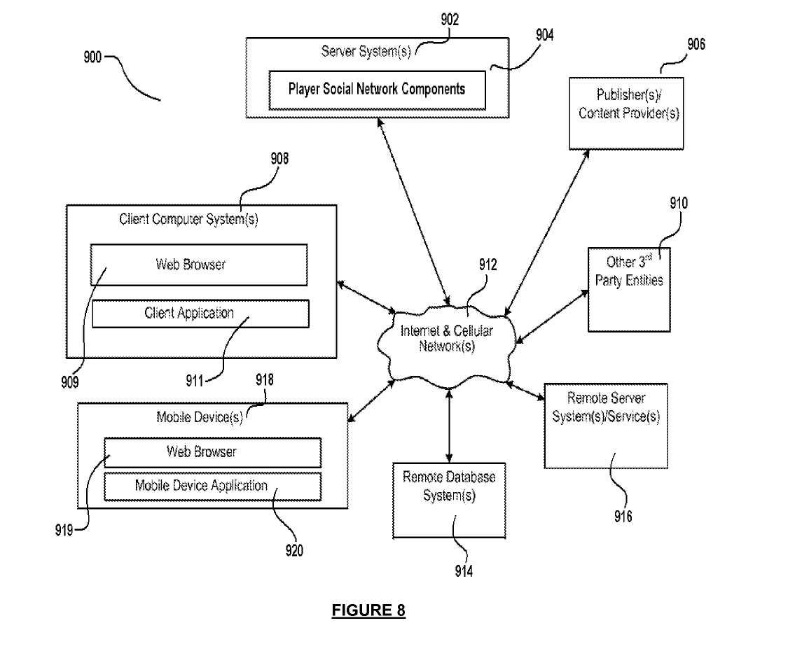

FIG. 8 illustrates a simplified block diagram of an alternative embodiment of a gaming network 900. As described herein, different embodiments of computer networks may be configured, designed, and/or operable to provide various different types of operations, functionalities, and/or features generally relating to allowing players to form a social network during gameplay. Many of the various operations, functionalities, and/or features of the gaming network(s) disclosed herein may provide or enable different types of advantages and/or benefits to different entities interacting with the gaming network(s).

According to different embodiments, gaming network 900 may include a plurality of different types of components, devices, modules, processes, systems, etc., which, for example, may be implemented and/or instantiated via the use of hardware and/or combinations of hardware and software. For example, as illustrated in the example embodiment of FIG. 8, gaming network 900 may include one or more of the following types of systems, components, devices, processes, etc., or combinations thereof. The network may include server system(s) 902. In one embodiment, the server system(s) may be operable to perform and/or implement various types of functions, operations, actions, and/or other features such as those described or referenced herein. In one embodiment, server system 902 may be configured or designed to include player social network components 904 for providing functionality relating to one or more of the player social network aspects disclosed herein, such as by providing communication between players, play code tracking, future event associated or disassociation, game updates, etc., as known to those of skill in the art.

Network 900 may also include: publisher/content provider system component(s) 906 for providing game play, themes, announcements, etc.; client computer system(s) 908, including associated web browser(s) 909 or client applications 911; third party systems 910, such as those used to provide advertisement capabilities, third party promotional offers, etc.; internet & cellular network(s) 110 for allowing players to use personal mobile devices or other platforms to access network 900 and perform game play functions; remote database system(s) 914, such as databases for containing play code transmission data, prize linkages, descriptions of social networks established by game play, etc.; remote server system(s)/service(s) 170, which, for example, may include, but are not limited to, one or more of the following, or combinations thereof: content provider servers/services, media streaming servers/services, database storage/access/query servers/services, financial transaction servers/services, payment gateway servers/services, electronic commerce servers/services, event management/scheduling servers/services, etc.

Network 900 may also include mobile device(s) 918, which, for example, may include, but are not limited to, one or more of the following, or combinations thereof: gaming machines, vending machines, televisions, kiosks, consumer devices, smart phones, video game consoles, personal computer systems, electronic display systems, etc., including web browser(s) 919 and mobile device application(s) 920 relating thereto such as “apps” or programs. In at least one embodiment, mobile device(s) 918 may be operable to perform and/or implement various types of functions, operations, actions, and/or other features such as those described or referenced herein (e.g., such as those illustrated and/or described with respect to the above FIGURES.

As used herein the singular forms “a,” “an,” and “the” include plural referents. Unless defined otherwise, technical and scientific terms used herein have the same meaning as is commonly understood by one of skill.

The material particularly shown and described above is not meant to be limiting, but instead serves to show and teach various exemplary implementations of the present subject matter. As set forth in the attached claims, the scope of the present invention includes both combinations and sub-combinations of various features discussed herein, along with such variations and modifications as would occur to a person of skill in the art.

What is claimed is:

1. A computer-implemented method for creating a shared social gaming experience, comprising:
allowing a first player to purchase, via a server, a first game entry;
the server assigning at least a first plurality of indicia to the first game entry;
the server linking the first plurality of indicia to a future event, such that the future event will determine a prize for the first game entry, if the first game entry is a winning entry;
the server assigning a play code to the first game entry;
allowing the first player to purchase, via the server, at least one future credit associated with the first game entry;
allowing the first player to use the at least one future credit to transfer the play code to a second player; and
allowing the second player to use the play code to create a second game entry, wherein creating the second game entry causes the prize of the first game entry to no longer be based on linking the first plurality of indicia to the future event.

2. The method of claim 1, wherein upon creation of the second game entry:
the server generates at least a second plurality of indicia for the second game entry;
the server bases the prize of the first game entry upon a correlation of matches between the first plurality of indicia and the second plurality of indicia; and
the server associates a prize with the second game entry based on linking the second plurality of indicia to the future event, such that the future event will determine a prize for the second game entry, if the second game entry is a winning entry.

3. The method of claim 2, wherein the second player may also be awarded an additional prize based on the correlation of matches between the first plurality of indicia and the second plurality of indicia.

4. The method of claim 1, wherein remaining future credits may be retained with the first game entry, transferred along with the play code, or a portion of the future credits may be retained with the first game entry while another portion is transferred along with the play code.

5. The method of claim 4, wherein future credits transferred to the second player may be retained by the second player or transferred to at least one additional player; and
subsequent future credit transfers are possible by one or more of the additional downstream players as long as there is at least one future credit remaining to use for transfer of the play code.

6. The method of claim 5, wherein for each subsequent transfer, no prize associated with a game entry transferring the play code is linked to the future event;
a prize for the game entry transferring the play code is determined by a correlation of matches between at least one plurality of indicia associated with the game entry making the transfer and at least one plurality of indicia generated for a next subsequent game entry; and
a prize for the next subsequent game entry is based on at least one plurality of indicia generated for the next subsequent game entry and is linked to the future event, such that the future event will determine a prize for the next subsequent game entry, if the next subsequent game entry is a winning entry.

7. The method of claim 1, wherein the at least one future credit must be used by a set time before occurrence of the future event; and
if the at least one future credit is not used by the set time, the server will use the at least one future credit to purchase additional entries for each player retaining at least one future credit, wherein at least one plurality of indicia associated with each player's respective game entry will be used for all additional game entries until the future credits are consumed.

8. The method of claim 1, wherein the second player may refuse to use the play code and thereby prevent creation of the second game entry.

9. The method of claim 8, wherein if the second game entry is not created, only the first game entry is linked to the future event.

10. The method of claim 1, wherein the first player selects at least the first plurality of player indicia.

11. The method of claim 1, wherein at least the first plurality of player indicia are selected for the first player.

12. The method of claim 1, wherein the first game entry is a printed ticket.

13. The method of claim 1, wherein the first game entry is an electronic ticket.

14. A gaming system for a social gaming experience, comprising:
a first game entry containing at least a first plurality of player indicia;
the first plurality of player indicia are linked to a future event, via a server, such that the future event will determine a prize for the first game entry, if the first game entry is a winning entry;
a play code associated with the game entry;
at least one future credit associated with the game entry;
wherein use of the at least one future credit by a first player transfers the play code to a second player;
wherein transfer of the play code to the second player, and use of the play code by the second player, creates a second game entry;
at least a second plurality of indicia are provided, free of player influence, for the second entry; and
the prize for the first game entry is unlinked, via the server, from the future event and is determined by a correlation of matches between the first plurality of indicia and the second plurality of indicia.

15. The gaming system of claim 14, wherein upon creation of the second game entry:
a prize for the second game entry is based on the second plurality of indicia and is linked to the future event, via the server, such that the future event will determine a prize for the second game entry, if the second game entry is a winning entry.

16. The gaming system of claim 15, wherein the second player may also be awarded an additional prize based on the correlation of matches between the first plurality of indicia and the second plurality of indicia.

17. The gaming system of claim 14, wherein remaining future credits may be retained with the first game entry, transferred along with the play code, or a portion of the remaining future credits may be retained with the first game entry and another portion transferred along with the play code.

18. The gaming system of claim 17, wherein future credits transferred to the second player may be retained by the second player or transferred to at least one additional player; and
subsequent transfers are possible as long as there is at least one future credit remaining to use for transfer of the play code.

19. The gaming system of claim 18, wherein for each subsequent transfer, a prize associated with a game entry transferring the play code is no longer linked to the future event via the server;
the prize of the game entry transferring the play code is determined by a correlation of matches between at least one plurality of indicia associated with the entry transferring the play code and at least one plurality of indicia generated for a next subsequent game entry; and
the prize for the next subsequent game entry is based on at least one plurality of indicia generated for the next subsequent entry being linked to the future event via the server, such that the future event will determine a prize for the next subsequent game entry, if the next subsequent game entry is a winning entry.

20. The gaming system of claim 14, wherein the at least one future credit must be used by a set time before occurrence of the future event; and
if the at least one future credit is not used by the set time, the server will use the at least one future credit to purchase additional entries for a player using a plurality of indicia associated with the player's game entry for all additional entries until the future credits are consumed.

21. The gaming system of claim 14, wherein the second player may refuse to use the play code and thereby prevent creation of the second game entry.

22. The gaming system of claim 20, wherein if the second game entry is not created, only the first game entry is linked to the future event via the server.

23. The gaming system of claim 14, wherein the first player selects at least the first plurality of player indicia.

24. The gaming system of claim 14, wherein at least the first plurality of player indicia are selected for the first player by the server.

25. The gaming system of claim 14, wherein the first game entry is a printed ticket.

26. The gaming system of claim 14, wherein the first game entry is an electronic ticket.
